(19) United States
(12) Patent Application Publication
(10) Pub. No.: US 2025/0198779 A1
(43) Pub. Date: Jun. 19, 2025

(54) METHOD FOR ENERGY-SAVING DRIVING FOR MOBILITY DEVICES

(71) Applicant: HYUNDAI AUTOEVER CORP., Seoul (KR)

(72) Inventors: Moon Jeong KIM, Seoul (KR); Hwa Hyeon HONG, Seoul (KR); Won Mi AHN, Seoul (KR); Yeon Su KIM, Seoul (KR); Ye Won SEOL, Seoul (KR)

(21) Appl. No.: 18/955,268

(22) Filed: Nov. 21, 2024

(30) Foreign Application Priority Data
Dec. 18, 2023 (KR) 10-2023-0184456

(51) Int. Cl. G01C 21/34; G01C 21/36

(52) U.S. Cl. CPC G01C 21/3469; G01C 21/3492; G01C 21/3667; G01C 21/3697

(57) ABSTRACT

Methods and systems of a mobility device for energy-saving driving are described. According to one embodiment, a method comprises receiving a guide request of a first route to a first destination, comparing an amount of power required for driving of the first route with a battery charge amount of the mobility device, and determining a portion of the first route as an energy-saving mode driving section when it is determined that the battery charge amount of the mobility device for reaching the first destination is insufficient as a result of the comparison.

### STATEMENT REGARDING PRIOR DISCLOSURES BY THE INVENTORS

A non-patent literature entitled, “A Study of Electric Vehicle Navigation UX Utilizing Netnography and TeB Methodology,” which was published on or around Jun. 23, 2023, is not prior art under 35 U.S.C. 102 (b) as being a disclosure made directly or indirectly by the inventor or a joint inventor 1 year or less before the effective filing date of the instant application. A copy of the non-patent literature prior disclosure is being submitted with the instant application in an Information Disclosure Statement pursuant to 37 CFR 1.97 and 1.98.

### CROSS-REFERENCE TO RELATED APPLICATION

This application claims priority from Korean Patent Application No. 10-2023-0184456 filed on Dec. 18, 2023 in the Korean Intellectual Property Office and all the benefits accruing therefrom under 35 U.S.C. 119, the contents of which in its entirety are herein incorporated by reference.

### BACKGROUND

### Technical Field

The present disclosure relates to a method for energy-saving driving for a mobility device and a navigation system to which the method is applied, and more particularly, to a method of providing a route in response to a user's request to activate an energy-saving mode and a navigation system to which the method is applied.

### Description of the Related Art

With the recent revitalization of the supply of electric vehicles, the supply of electric vehicle charging stations is also accelerating. However, compared to a supply rate of the electric vehicles, the supply of electric vehicle charging stations is still poor, and electric vehicle users are having difficulty in charging.

Accordingly, electric vehicle users may find it difficult to reach their desired destination due to a lack of a battery charge amount. In order to solve the above problem, a conventional technology for making sure of a maximum available driving distance through an energy-saving mode that restricts excessive output waste such as rapid acceleration of an electric vehicle has been proposed.

However, since the above-described conventional technology activates and deactivates the energy-saving mode through a user's input, when the user does not want the energy-saving mode, the user should perform an input for deactivating the energy-saving mode separately while driving. In addition, since the conventional energy-saving mode technology only restricts the output of the electric vehicle, there is a problem that the effect of making sure of the available driving distance is also insignificant.

Accordingly, the energy-saving mode driving technology of the electric vehicle is required to make sure of a maximum available driving distance by automatically activating and deactivating the energy-saving mode in accordance with a driving state of the electric vehicle and deactivating the electric vehicle's electronic control function, but this technology has not been provided.

### BRIEF SUMMARY

An object of the present disclosure is to provide a method for energy-saving driving for a mobility device that may reach a destination, which cannot be reached by a current charge amount of the mobility device, while minimizing inconvenience of inability to use an electronic control function due to an energy-saving mode.

Another object of the present disclosure is to provide a method of additionally making sure of an available driving distance of a mobility device by minimizing power loss caused by electronic control actuation of the mobility device.

Still another object of the present disclosure is to provide a method of preventing unexpected power shortages.

Further still another object of the present disclosure is to provide a navigation interface that enables a user to previously check a driving section in an energy-saving mode before starting to drive a route.

Further still another object of the present disclosure is to provide a method of guiding a route with good power efficiency to a user by continuously searching for such a route while driving.

The objects of the present disclosure are not limited to those mentioned above and additional objects of the present disclosure, which are not mentioned herein, will be clearly understood by those skilled in the art from the following description of the present disclosure.

According to some embodiments of the present disclosure, a method for energy-saving driving of a mobility device is provided. Which is performed by a computing system. The method may include: receiving a guide request of a first route to a first destination from a user, comparing the amount of power required for driving of the first route with a battery charge amount of a mobility device and determining a portion of the first route as an energy-saving mode driving section when it is determined that the battery charge amount of the mobility device for reaching the first destination is insufficient as a result of the comparison. The determining a portion of the first route as an energy-saving mode driving section may include: determining a traffic congestion section included in the first route as the energy-saving mode driving section and determining at least a portion of the other section excluding the traffic congestion section from the remaining section to the first destination included in the first route as an additional energy-saving mode driving section.

In some embodiments, the method may further include transmitting a control request for any one of actuators included in the mobility device to an electronic control unit (ECU) of the mobility device in accordance with a determination that the mobility device has entered the energy-saving mode driving section.

In some embodiments, the method may further include changing the first route to a route passing through a charging station when it is determined that the battery charge amount of the mobility device for reaching the first destination is insufficient as a result of the comparison.

In some embodiments, the method may further include determining a section from a first point included in the first route, in which the battery charge amount of the mobility device is a reference value or less when driving in the first route, to the first destination as the energy-saving mode driving section.

In some embodiments, the method may further include displaying a first map including the first route and displaying the first map by overlaying the energy-saving mode driving section on the first route displayed on the first map.

In some embodiments, the displaying the first map including the first route may include displaying information on an energy-saving running time, the amount of power saved by an energy-saving mode, an additional available driving distance due to the energy-saving mode, and a reason for activating the energy-saving mode in each energy-saving mode driving section.

In some embodiments, the method may further include displaying information on a second route to the first destination while the mobility device is driving the first route to the first destination. The information on the second route may include information on the amount of power saved due to driving of the second route compared to driving of the first route, and ETA information changed by driving of the second route.

In some embodiments, the method may further include displaying information on a distance driven in the energy-saving mode, the amount of power saved by driving in the energy-saving mode and an additional available driving distance caused by driving in the energy-saving mode in accordance with a determination that the mobility device has reached the first destination.

According to some embodiments of the present disclosure, a navigation system is provided. The navigation system may include one or more processors and a memory storing one or more instructions. The one or more processors, by executing the one or more stored instructions, may perform an operation of receiving a guide request of a first route to a first destination from a user, an operation of comparing the amount of power required for driving of the first route with a battery charge amount of a mobility device and an operation of determining a portion of the first route as an energy-saving mode driving section when it is determined that the battery charge amount of the mobility device for reaching the first destination is insufficient as a result of the comparison. the operation of determining a portion of the first route as an energy-saving mode driving section may include an operation of determining a traffic congestion section included in the first route as the energy-saving mode driving section and an operation of determining at least a portion of the other section excluding the traffic congestion section from the remaining section to the first destination included in the first route as an additional energy-saving mode driving section.

In some embodiments, the one or more processors may further perform an operation of transmitting a control request for any one of actuators included in the mobility device to an electronic control unit (ECU) of the mobility device in accordance with a determination that the mobility device has entered the energy-saving mode driving section.

In some embodiments, the one or more processors may further perform an operation of changing the first route to a route passing through a charging station when it is determined that the battery charge amount of the mobility device for reaching the first destination is insufficient as a result of the comparison.

In some embodiments, the one or more processors may further perform an operation of displaying a first map including the first route and displaying the first map by overlaying the energy-saving mode driving section on the first route displayed on the first map.

In some embodiments, the operation of displaying the first map including the first route may include an operation of displaying information on an energy-saving running time, the amount of power saved by an energy-saving mode, an additional available driving distance due to the energy-saving mode, and a reason for activating the energy-saving mode in each energy-saving mode driving section.

In some embodiments, the one or more processors may further perform an operation of displaying information on a second route to the first destination while the mobility device is driving the first route to the first destination, the information on the second route may include information on the amount of power saved due to driving of the second route compared to driving of the first route, and ETA information changed by driving of the second route.

In some embodiments, the one or more processors may further perform an operation of determining a section from a first point included in the first route, in which the battery charge amount of the mobility device is a reference value or less when driving in the first route, to the first destination as the energy-saving mode driving section.

In some embodiments, the one or more processors may further perform an operation of displaying information on a distance driven in an energy-saving mode, the amount of power saved by driving in the energy-saving mode and an additional available driving distance caused by driving in the energy-saving mode in accordance with a determination that the mobility device has reached the first destination.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a view illustrating an exemplary environment to which a navigation system according to one embodiment of the present disclosure may be applied;

FIG. 2 is a flow chart illustrating a method for energy-saving driving for a mobility device according to another embodiment of the present disclosure;

FIG. 3 is a view exemplarily illustrating a step of displaying a pop-up notifying that a first destination, which may be performed in some embodiments of the present disclosure, is unreachable.

FIG. 4 is a view exemplarily illustrating a step of displaying a first map, which may be performed in some embodiments of the present disclosure;

FIG. 5 is a view exemplarily illustrating a step of displaying a first map, which may be performed in some embodiments of the present disclosure;

FIG. 6 is a view exemplarily illustrating a step of displaying information on a reason for activating an energy-saving mode, which may be performed in some embodiments of the present disclosure;

FIG. 7 is a view exemplarily illustrating a step of displaying information on a reason for activating an energy-saving mode, which may be performed in some embodiments of the present disclosure;

FIG. 8 is a view exemplarily illustrating a step of displaying a second route, which may be performed in some embodiments of the present disclosure;

FIG. 9 is a view exemplarily illustrating a step of displaying energy-saving mode driving information after reaching a first destination, which may be performed in some embodiments of the present disclosure; and

FIG. 10 is a hardware schematic view illustrating a navigation system according to another embodiment of the present disclosure.

### DETAILED DESCRIPTION OF THE DISCLOSURE

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, some embodiment of the present disclosure will be described with reference to the accompanying drawings.

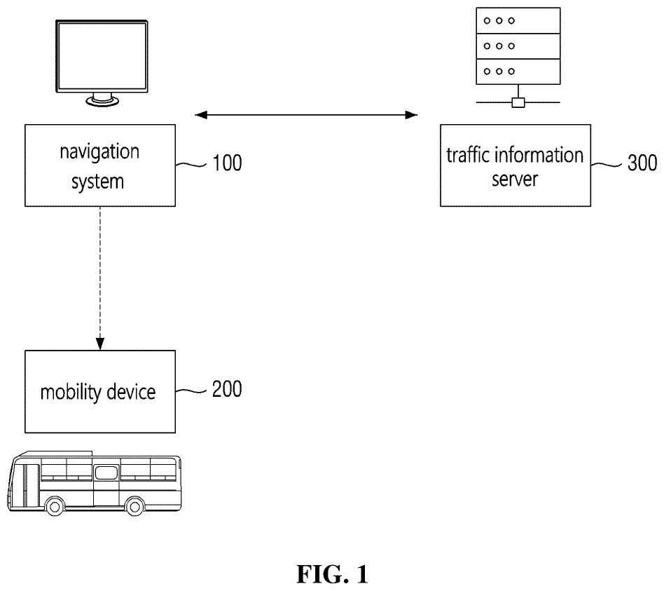

FIG. 1 is a view illustrating an exemplary environment to which a navigation system 100 according to one embodiment of the present disclosure may be applied.

In some embodiments of the present disclosure, the navigation system 100 may perform communicate with other components through a network. The network may be implemented as all types of wired/wireless networks such as a local area network (LAN), a wide area network (WAN), a mobile radio communication network, and a Wireless Broadband Internet (Wibro).

Each component shown in FIG. 1 may mean software or hardware such as a Field Programmable Gate Array (FPGA) or an Application-Specific Integrated Circuit (ASIC). However, the components are not limited to software or hardware, and may be configured to be in a storage medium capable of addressing, or may be configured to execute one or more processors. The functions provided in the components may be implemented by a more subdivided component, or may be implemented as a single component that performs a specific function by combining a plurality of components.

A mobility device 200 shown in FIG. 1 may be any one of a vehicle, a locomotive, an electric vehicle, an autonomous vehicle, a bicycle, a shared kickboard, and an unmanned aerial vehicle (UAV). In addition, the power used by the mobility device 200 may be an engine, electric power, wind power, or tidal power.

The navigation system 100 according to one embodiment of the present disclosure may receive a guide request of a first route to a first destination from a user.

The navigation system 100 according to another embodiment of the present disclosure may compare the amount of power required for driving of the first route with a battery charge amount of the mobility device 200.

The navigation system 100 according to another embodiment of the present disclosure may determine a portion of the first route as an energy-saving mode driving section when it is determined that the battery charge amount of the mobility device for reaching the first destination is insufficient as a result of the above comparison.

In some embodiments of the present disclosure, the navigation system 100 may transmit an energy-saving mode execution request to the mobility device 200 in accordance with the determination that the mobility device 200 has entered the energy-saving mode driving section.

In some other embodiments of the present disclosure, an electronic control function of the mobility device 200, which is deactivated due to the energy-saving mode, may be preset by the user.

In some other embodiments of the present disclosure, the navigation system 100 may transmit a control request for any one of actuators included in the mobility device 200 to an Electronic Control Unit (ECU) of the mobility device 200 in accordance with the determination that the mobility device 200 has entered the energy-saving mode driving section.

In some other embodiments of the present disclosure, the actuator control request may include an air conditioner actuator control request of the mobility device 200.

In some other embodiments of the present disclosure, the actuator control request may include an actuator control request of a terminal charging device of the mobility device 200.

In some other embodiments of the present disclosure, the actuator control request may include an actuator control request of an audio system of the mobility device 200.

In some other embodiments of the present disclosure, the navigation system 100 may stop receiving Over The Air (OTA) firmware information in accordance with the determination that the mobility device 200 has entered the energy-saving mode driving section.

In some other embodiments of the present disclosure, the navigation system 100 may limit the output of a power train of the mobility device 200 in accordance with the determination that the mobility device 200 has entered the energy-saving mode driving section.

The navigation system 100 according to another embodiment of the present disclosure may receive traffic information of the first route from a traffic information server 300.

The navigation system 100 according to another embodiment of the present disclosure may determine a traffic congestion section included in the first route as the energy-saving mode driving section based on the received traffic information of the first route.

The navigation system 100 according to another embodiment of the present disclosure may determine a section from a first point included in the first route, in which the battery charging amount of the mobility device 200 is a reference value or less when the first route is driven, to the first destination as the energy-saving mode driving section.

The components included in an exemplary environment to which the navigation system 100 may be applied and the operations that may be performed by the components have been described with reference to FIG. 1 as above. It should be understood that the above-described embodiments are exemplary in all aspects and are not restrictive. In addition, the configuration and operation of the navigation system 100 according to the present embodiment may be supplemented through some embodiments that will be described below.

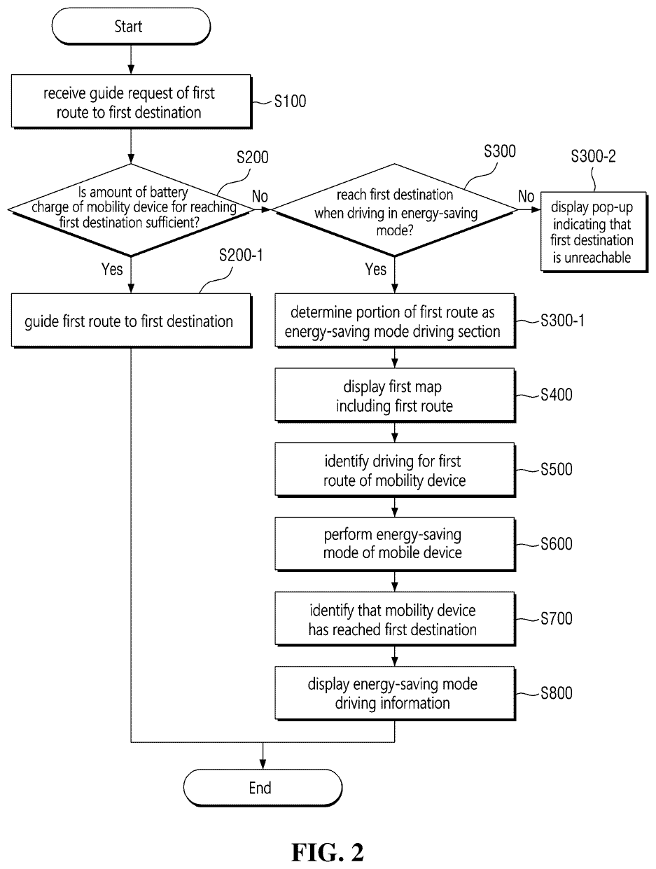

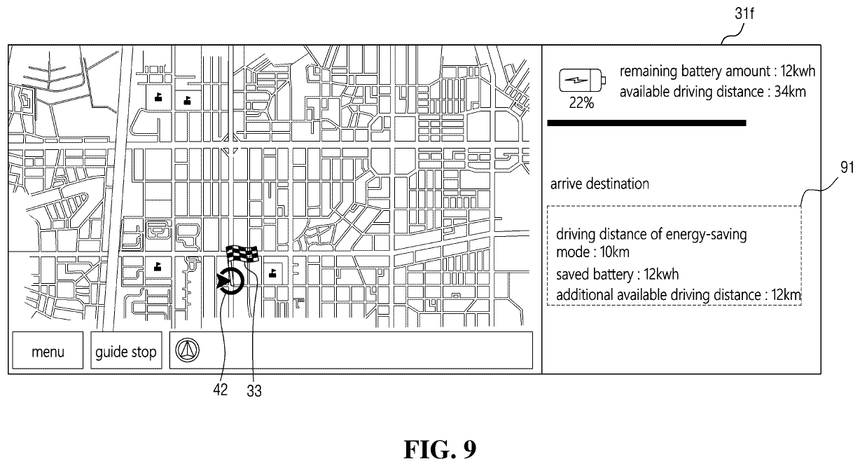

Hereinafter, a method for energy-saving driving for a mobility device according to another embodiment of the present disclosure will be described with reference to FIGS. 2 to 9. The steps described in some flow charts below may be understood to be performed by the navigation system 100 described with reference to FIG. 1 unless otherwise stated. Also, it will be apparent that the technical spirits understood in the embodiment described with reference to FIG. 1 may be applied to the method for energy-saving driving for a mobility device according to the present embodiment.

FIG. 2 is a flow chart illustrating a method for energy-saving driving for a mobility device according to another embodiment of the present disclosure.

In step S100 shown in FIG. 2, the navigation system 100 may receive a guide request of a first route to a first destination from a user.

In some embodiments related to step S100, the guide request of the first route may be received from a user terminal of the user.

In step S200, the navigation system 100 may determine whether the battery charge amount of the mobility device 200 for driving the first route to the first destination is sufficient.

In some embodiments related to step S200, the navigation system 100 may compare the amount of power required for driving of the first route with the current amount of battery charge of the mobility device 200.

In step S200-1, as a result of comparing the amount of power required for driving of the first route with the current amount of battery charge of the mobility device 200, when the current amount of battery charge of the mobility device 200 is greater than the amount of power required for driving of the first route as much as a reference value or more, the navigation system 100 may determine that the battery charge amount of the mobility device 200 for driving the first route is sufficient, and may guide the first route to the first destination in accordance with the above determination.

In step S300, when the current amount of battery charge of the mobility device 200 is smaller than the power required for driving of the first route as much as a reference value or more, the navigation system 100 may determine that the battery charge amount of the mobility device 200 for driving the first route is insufficient, and may determine whether the mobility device 200 may reach the first destination when driving in the energy-saving mode.

In some embodiments related to step S300, the energy-saving mode driving may mean that the mobility device 200 drives a partial section of the first route to the first destination in the energy-saving mode. Also, the energy-saving mode of the mobility device 200 may be clearly understood with reference to the embodiments described with reference to FIG. 1.

In step S300-2, the navigation system 100 may display a pop-up indicating that the first destination is an unreachable destination as it is determined that the battery charge amount of the mobility device 200 for driving the first route is insufficient despite the driving of the mobility device 200 in the energy-saving mode.

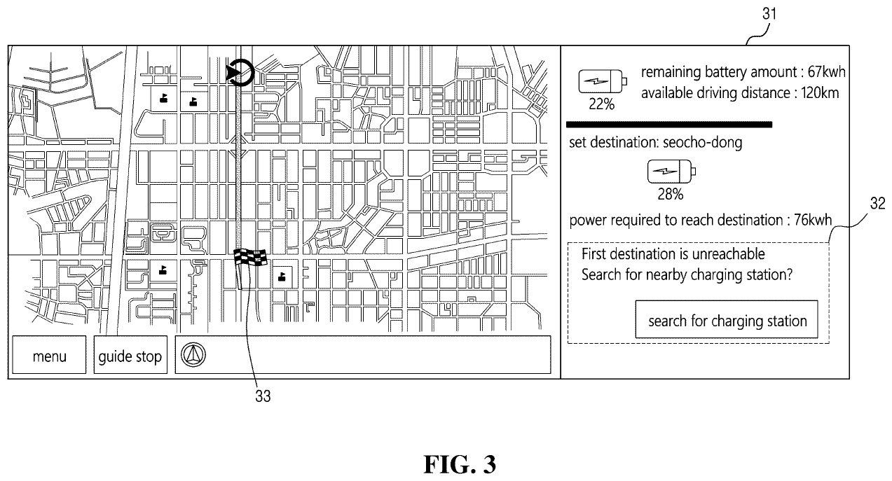

In some embodiments related to step S300-2, referring to FIG. 3, on a first screen 31 of the navigation system 100, the navigation system 100 may display a pop-up 32 indicating that the first destination is an unreachable destination as it is determined that the mobility device 200 cannot reach the first destination 33 despite its driving in the energy-saving mode.

In some other embodiments related to step S300-2, as shown in FIG. 3, the navigation system 100 may ask the user whether to search for a charging station existing within a predefined distance of the mobility device 200 as it is determined that the mobility device 200 cannot reach the first destination 33 despite its driving in the energy-saving mode.

In step S300-1, the navigation system 100 may determine a portion of the first route as an energy-saving mode driving section as it is determined that the mobility device 200 may reach the first destination when driving in the energy-saving mode.

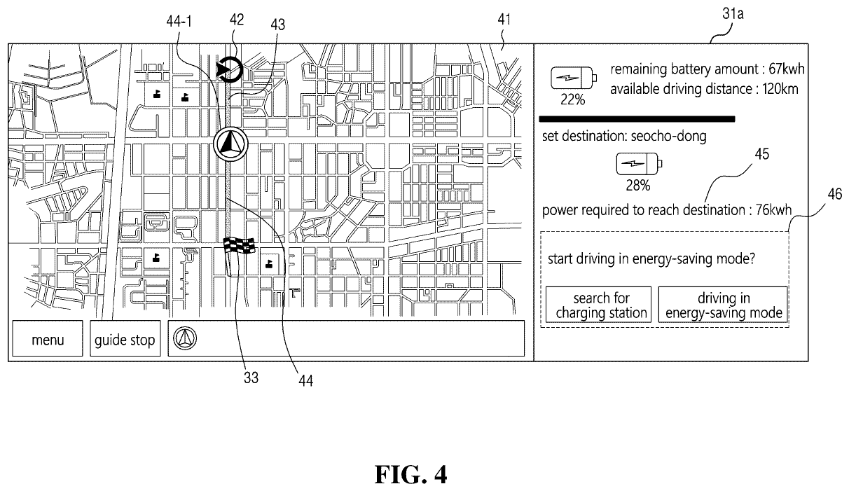

In some embodiments related to step S300-1, referring to FIG. 4, on a second screen 31a of the navigation system 100, the navigation system 100 may determine a first section 43 as an energy-saving mode driving section as it is determined that the mobility device 200 may reach the first destination 33 from a current position 42 of the mobility device 200 when driving in the energy-saving mode and the first section 43 is determined as a congested section based on the traffic information received from the traffic information server 300.

In some other embodiments related to step S300-1, referring to FIG. 4, the navigation system 100 may determine a second section 44 from a first point 44-1 to the first destination 33 as an energy-saving mode driving section as it is determined that the battery charge amount of the mobility device 200 becomes a reference value or less at the first point 44-1 of the first route as result of driving of the first route of the mobility device 200 to the first destination 33.

According to the present embodiment, the navigation system 100 may achieve the effect of preventing unexpected power shortages.

In some other embodiments related to step S300-1, the navigation system 100 may transmit a control request for any one of the actuators included in the mobility device 200 to the ECU of the mobility device 200 when it is determined that the mobility device 200 has entered any one of the first section 43 and the second section 44, which is determined as the energy-saving mode driving section.

According to the present embodiment, the navigation system 100 may achieve the effect of additionally making sure of the available driving distance of the mobility device 200 by minimizing power loss due to the electronic control actuation of the mobility device 200.

In step S400, the navigation system 100 may display a first map, which includes the first route, on the screen.

In some embodiments related to step S400, referring to FIG. 4, the navigation system 100 may display the current position 42 of the mobility device 200, the first section 43 and the second section 44, which are determined as the energy-saving mode driving sections, on the first map 41 by overlaying them.

According to the present embodiment, the user may check a section to be driven in the energy-saving mode in advance before departure.

In some other embodiments related to step S400, referring to FIG. 4, the navigation system 100 may display information 45 on the battery charge amount required for the mobility device 200 to reach the first destination 33.

In some other embodiments related to step S400, referring to FIG. 4, the navigation system 100 may display a pop-up 46 asking the user whether to perform driving in the energy-saving mode. In addition, the navigation system 100 may search for a charging station existing within a predefined distance of the mobility device 200 as the user does not want to perform driving in the energy-saving mode and thus inputs a charging station search button.

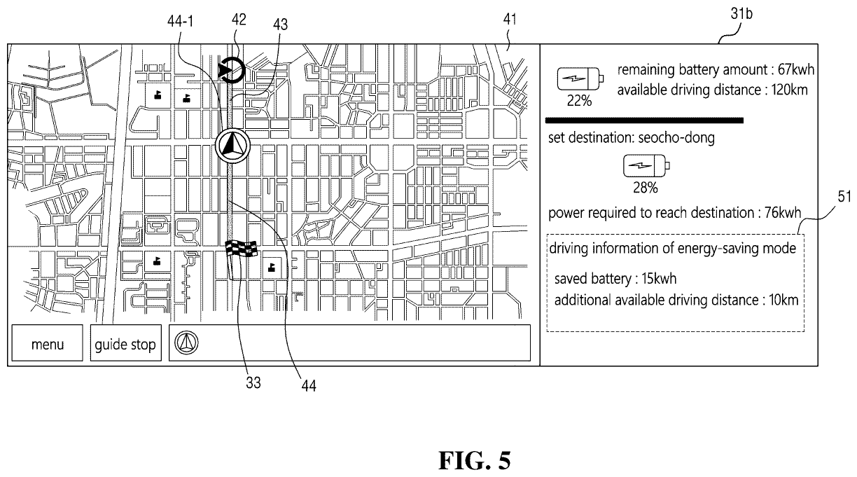

In some other embodiments related to step S400, referring to a third screen 31b of the navigation system 100 of FIG. 5, the navigation system 100 may display energy-saving mode driving information 51. In this case, the energy-saving mode driving information 51 may include information on the battery charge amount of the mobility device 200, which is saved by driving in the energy-saving mode, and an additional available driving distance secured by driving in the energy-saving mode.

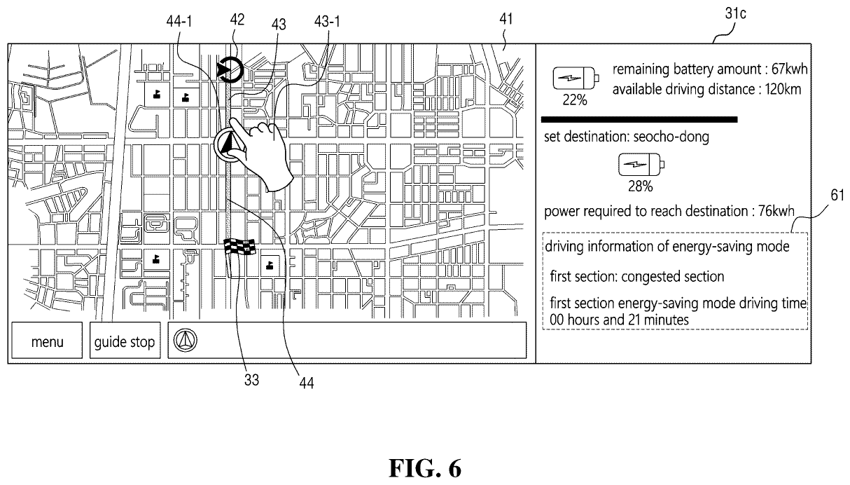

In some other embodiments related to step S400, referring to a fourth screen 31c of the navigation system 100 of FIG. 6, the navigation system 100 may display energy-saving mode driving information 61 corresponding to the first section 43 in accordance with the user's first input 44-1 for the first section 43 of the first map 41. The energy-saving mode driving information 61 corresponding to the first section 43 may include information on a reason for activating the energy-saving mode in the first section 43 and a driving time in the energy-saving mode in the first section 43.

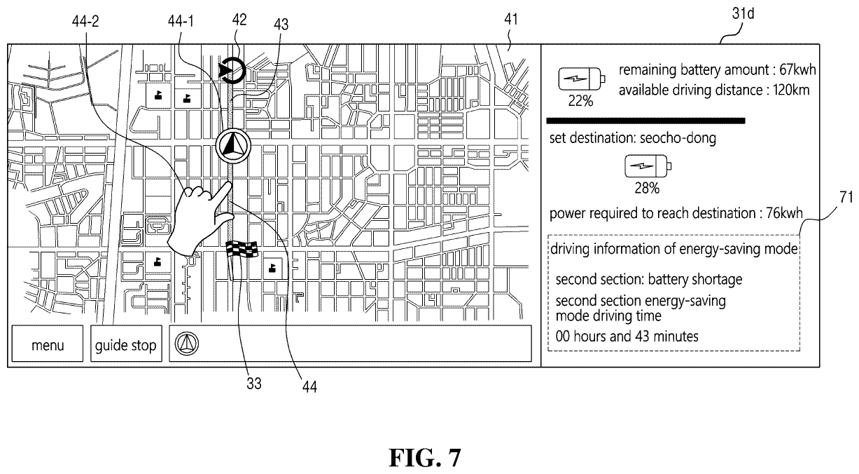

In some other embodiments related to step S400, referring to a fifth screen 31d of the navigation system 100 of FIG. 7, the navigation system 100 may display energy-saving mode driving information 71 corresponding to the second section 44 in accordance with the user's second input 44-2 for the second section 44 of the first map 41. The energy-saving mode driving information 71 corresponding to the second section 44 may include information on a reason for activating the energy-saving mode in the second section 44 and a driving time in the energy-saving mode in the second section 44.

Next, in step S500, the navigation system 100 may identify the driving of the mobility device 200 for the first route.

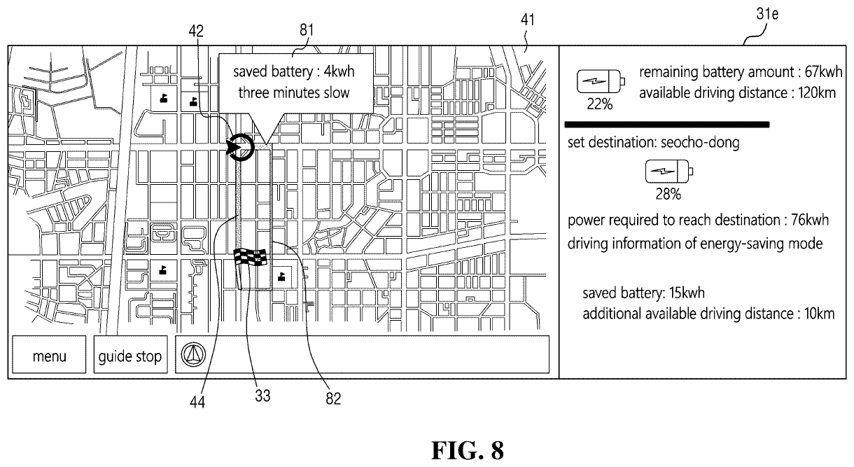

In some embodiments related to step S500, referring to a sixth screen 31e of the navigation system 100 of FIG. 8, the navigation system 100 may overlay and display a second route 82 for the first destination 33 on the first map 41 while the mobility device 200 is driving the first route.

In some other embodiments related to step S500, referring to FIG. 8, the navigation system 100 may display information 81 of the second route 82. In this case, the information 81 of the second route 82 may include information on the amount of power that can be saved when driving the second route 82, compared to continuing to drive the first route currently being driven by the mobility device 200, and information on Estimated Time of Arrival (ETA) that is changed when driving the second route 82.

According to the present embodiment, the navigation system may achieve the effect of maximizing the available driving distance of the mobility device by continuously searching for a route with good power efficiency.

In step S600, the navigation system 100 may request the mobility device 200 to perform the energy-saving mode in accordance with the determination that the mobility device 200 has entered the energy-saving mode driving section.

In some embodiments related to step S600, the navigation system 100 may request the mobility device 200 to terminate the energy-saving mode in accordance with the determination that the mobility device 200 has deviated from the energy-saving mode driving section.

In step S700, the navigation system 100 may identify the arrival of the mobility device 200 to the first destination.

In step S800, as the navigation system 100 identifies the arrival of the first destination of the mobility device 200, the navigation system 100 may display summary information of the energy-saving mode driving.

In some embodiments related to step S800, the navigation system 100 may determine that the mobility device 200 has reached the first destination 33 and display summary information 91 of the energy-saving mode driving in accordance with the determination that the current position 42 of the mobility device 200 exists within a predefined distance from the first destination 33.

In some embodiments related to step S800, the summary information 91 of the energy-saving mode driving may include information on the distance that the mobility device 200 has driven in the energy-saving mode, the battery charge amount of the mobility device 200, which is saved by driving in the energy-saving mode, and the available driving distance of the mobility device 200, which is secured by driving in the energy-saving mode.

The method for energy-saving driving for a mobility device according to another embodiment of the present disclosure has been described with reference to FIGS. 2 to 9. It should be understood that the above-described embodiments are illustrative in all aspects and are not restrictive.

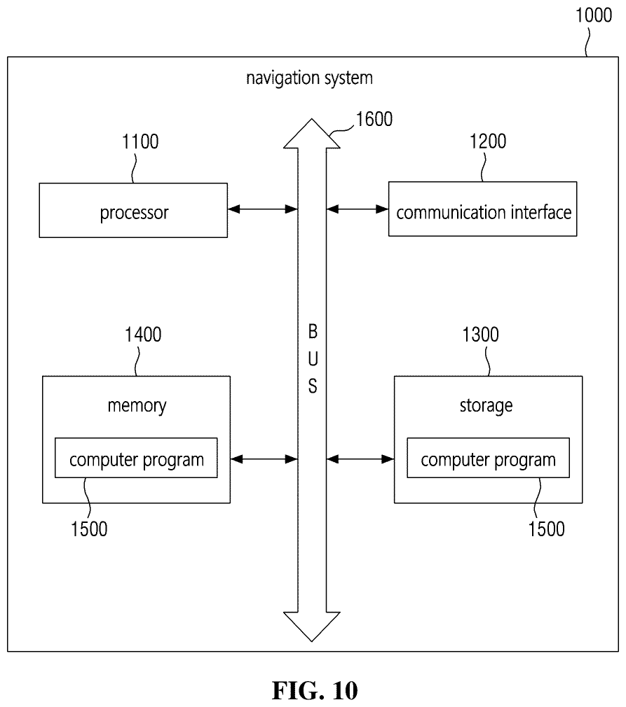

FIG. 10 is a hardware schematic view illustrating a navigation system 1000 according to another embodiment of the present disclosure. The navigation system 1000 of FIG. 10 may indicate the navigation system 100 described with reference to FIG. 1, for example. In addition, the navigation system 1000 may be a navigation device mounted on the mobility device 200 shown in FIG. 1. The navigation system 1000 may include one or more processors 1100, a system bus 1600, a communication interface 1200, and a memory 1400 for loading a computer program 1500 performed by the processor 1100, and a storage 1300 for storing the computer program 1500.

In this case, the communication interface 1200 may receive driving information of the mobility device in real time by being connected to an Electronic Control Unit (ECU) of the mobility device through a Controller Area Network (CAN).

The processor 1100 may control the overall operations of the components of the navigation system 1000. The processor 1100 may perform computations for at least one application or program for executing operations/methods according to some embodiments of the present disclosure. The memory 1400 may store various data, commands, and/or information. The memory 1400 may load the computer program 1500 from the storage 1300 to execute the operations/methods according to some embodiments of the present disclosure. The memory 1400 may be implemented as a volatile memory such as a random access memory (RAM), but the present disclosure is not limited thereto. The bus 1600 may provide communication functionally among the components of the navigation system 1000. The communication interface 1200 may support both wired and wireless Internet communication for the navigation system 1000. The storage may temporarily store at least one computer program 1500. The computer program 1500 may include one or more instructions that, upon being loaded into the memory 1400, direct the processor 1100 to perform the operations/methods according to some embodiments of the present disclosure. In other words, by executing the loaded instructions, the processor 1100 may perform the operations/methods according to some embodiments of the present disclosure.

some embodiments, the navigation system 1000 may refer to a virtual machine implemented based on cloud technology. For example, the navigation system 1000 may be a virtual machine operating on one or more physical servers within a server farm. In this example, at least some of the components of the navigation system 1000, i.e., the processor 1100, the memory 1400, and the storage 1300, may be implemented as virtual hardware, and the communication interface 1200 may be implemented as a virtual networking element such as a virtual switch.

The computer program 1500 may include instructions for performing an operation of receiving a guide request of a first route to a first destination from a user of the navigation system 1000, an operation of comparing the amount of power required for driving of the first route with a battery charge amount of the mobility device, an operation of determining a portion of the first route as an energy-saving mode driving section when it is determined that the battery charge amount of the mobility device for reaching the first destination is insufficient as a result of the comparison, and an operation of transmitting a control request for at least a portion of actuators existing in the mobility device to an ECU of the mobility device in accordance with the determination that the mobility device has reached the energy-saving mode driving section.

Various embodiments of the present disclosure and their effects have been described with reference to FIGS. 1 to 10. However, the technical concepts of the present disclosure are not limited to the effects set forth herein, and other effects not explicitly mentioned may be readily understood by those skilled in the art to which the present disclosure, from the provided description below.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method of a navigation device for energy-saving driving of a mobility device, the method comprising:
receiving a guide request of a first route to a first destination;
comparing an amount of power required for driving of the first route with a battery charge amount of the mobility device; and
determining a portion of the first route as an energy-saving mode driving section when it is determined that the battery charge amount of the mobility device for reaching the first destination is insufficient as a result of the comparison,
wherein the determining the portion of the first route as the energy-saving mode driving section includes:
determining a traffic congestion section included in the first route as the energy-saving mode driving section; and
determining at least a portion of other section excluding the traffic congestion section from a remaining section of the first route to the first destination as an additional energy-saving mode driving section.

2. The method of claim 1, further comprising transmitting a control request for any one of actuators included in the mobility device to an electronic control unit (ECU) of the mobility device in accordance with a determination that the mobility device has entered the energy-saving mode driving section.

3. The method of claim 1, further comprising changing the first route to a route passing through a charging station when it is determined that the battery charge amount of the mobility device for reaching the first destination is insufficient as a result of the comparison.

4. The method of claim 1, further comprising determining a section from a first point included in the first route to the first destination where the battery charge amount of the mobility device is equal to or less than a reference value when driving in the first route as the energy-saving mode driving section.

5. The method of claim 1, further comprising:
displaying a first map including the first route; and
displaying the first map by overlaying the energy-saving mode driving section on the first route displayed on the first map.

6. The method of claim 5, wherein the displaying the first map including the first route comprises displaying information on an energy-saving running time, an amount of power saved by an energy-saving mode, an additional available driving distance due to the energy-saving mode, and a reason for activating the energy-saving mode in each energy-saving mode driving section.

7. The method of claim 1, further comprising displaying an information on a second route to the first destination while the mobility device is driven through the first route to the first destination,
wherein the information on the second route includes an information on an amount of power saved due to driving of the second route compared to driving of the first route and an Estimated Time of Arrival (ETA) information changed by the driving of the second route.

8. The method of claim 1, further comprising displaying information on a distance driven in the energy-saving mode, an amount of power saved by driving in the energy-saving mode and an additional available driving distance caused by driving in the energy-saving mode in accordance with a determination that the mobility device has reached the first destination.

9. A navigation system of a mobility device, comprising:
at least one processor; and
a memory storing a set of instructions,
wherein the at least one processor, by executing the set of instructions, performs:
an operation of receiving a guide request of a first route to a first destination;
an operation of comparing an amount of power required for driving of the first route with a battery charge amount of the mobility device; and
an operation of determining a portion of the first route as an energy-saving mode driving section when it is determined that the battery charge amount of the mobility device for reaching the first destination is insufficient as a result of the comparison,
wherein the operation of determining the portion of the first route as the energy-saving mode driving section includes:
an operation of determining a traffic congestion section included in the first route as the energy-saving mode driving section; and
an operation of determining at least a portion of other section excluding the traffic congestion section from a remaining section of the first route to the first destination as an additional energy-saving mode driving section.

10. The navigation system of claim 9, wherein the at least one processor further performs an operation of transmitting a control request for any one of actuators included in the mobility device to an electronic control unit (ECU) of the mobility device in accordance with a determination that the mobility device has entered the energy-saving mode driving section.

11. The navigation system of claim 9, wherein the at least one processor further performs an operation of changing the first route to a route passing through a charging station when it is determined that the battery charge amount of the mobility device for reaching the first destination is insufficient as a result of the comparison.

12. The navigation system of claim 9, wherein the at least one processor further performs an operation of displaying a first map including the first route; and
displaying the first map by overlaying the energy-saving mode driving section on the first route displayed on the first map.

13. The navigation system of claim 12, wherein the operation of displaying the first map including the first route comprises an operation of displaying information on an energy-saving running time, an amount of power saved by an energy-saving mode, an additional available driving distance due to the energy-saving mode, and a reason for activating the energy-saving mode in each energy-saving mode driving section.

14. The navigation system of claim 9, wherein the at least one processor further performs an operation of displaying an information on a second route to the first destination while the mobility device is driven through the first route to the first destination, and
the information on the second route includes information on an amount of power saved due to driving of the second route compared to driving of the first route and an ETA information changed by the driving of the second route.

15. The navigation system of claim 9, wherein the at least one processor further performs an operation of determining a section from a first point included in the first route to the first destination where the battery charge amount of the mobility device is equal to or less than a reference value when driving in the first route as the energy-saving mode driving section.

16. The navigation system of claim 9, wherein the at least one processor further performs an operation of displaying information on a distance driven in an energy-saving mode, an amount of power saved by driving in the energy-saving mode and an additional available driving distance caused by driving in the energy-saving mode in accordance with a determination that the mobility device has reached the first destination.
